(19) United States
(12) Patent Application Publication
(10) Pub. No.: US 2025/0204546 A1
(43) Pub. Date: Jun. 26, 2025

(54) A FAT COMPOSITION COMPRISING A VEGETABLE FAT PHASE WHICH IS FREE FROM PALM OIL AND/OR FRACTIONS THEREOF

(71) Applicant: AAK AB (PUBL), Malmö (SE)

(72) Inventor: Morten Daugaard ANDERSEN, Aarhus C (DK)

(21) Appl. No.: 18/850,160

(22) PCT Filed: Apr. 4, 2023
(86) PCT No.: PCT/SE2023/050303

§ 371 Date: Sep. 24, 2024

(30) Foreign Application Priority Data
Apr. 7, 2022 (SE) 2250440-1

(51) Int. Cl. A23D 9/04; A23G 1/36

(52) U.S. Cl. CPC A23D 9/04; A23G 1/36

(57) ABSTRACT

Disclosed is a fat composition comprising a vegetable fat phase, wherein the vegetable fat phase is free from palm oil and/or fractions thereof and also relates to the use of the fat composition. Further disclosed is a confectionary or chocolate or chocolate-like product comprising the fat composition. A fat composition as disclosed shows the possibility to produce chocolate-like compounds without the use of a palm based vegetable fat phase without comprising the quality.

### TECHNICAL FIELD OF THE INVENTION

The present invention relates to a fat composition comprising a vegetable fat phase, wherein the vegetable fat phase is free from palm oil and/or fractions thereof and also relates to the use of the fat composition. The invention further relates to a confectionary or chocolate or chocolate-like product comprising the fat composition.

### BACKGROUND OF THE INVENTION

Palm oil is an extremely versatile oil that has many different properties and functions that makes it so useful and so widely used. It is semi-solid at room temperature so can keep spreads spreadable; it is resistant to oxidation so can give products a longer shelf-life; it's stable at high temperatures so helps to give fried products a crispy and crunchy texture; and it's also odourless and colourless so doesn't alter the look or smell of food products.

As well as being versatile, compared to other vegetable oils the oil palm is a very efficient crop, able to produce high quantities of oil over small areas of land, almost all year round. This makes it an attractive crop for growers and smallholders, who can rely on the steady income that palm oil provides.

Palm oil is also found as an important component in cocoa butter equivalents (CBEs) used in the chocolate industry today. In CBE components palm mid fractions is used as one of the more important components.

Unfortunately, palm oil has been and continues to be a major driver of deforestation of some of the world's most biodiverse forests, destroying the habitat of already endangered species like the Orangutan, pygmy elephant, and Sumatran rhino. This forest loss coupled with conversion of carbon rich peat soils are throwing out millions of tonnes of greenhouse gases into the atmosphere and contributing to climate changes. There also remains some exploitation of workers and child labour. These are serious issues that the whole palm oil sector needs to address.

Therefore, non-palm oil sources in the vegetable oils and fats industry have become an important subject as an alternative to oil palms. Thus, there is a need in the art for such alternatives.

Accordingly, the main object of the invention is to provide such alternatives.

### SUMMARY OF THE INVENTION

The present invention relates to a fat composition comprising a vegetable fat phase, wherein the vegetable fat phase comprises:
from 85.0% to 100.0% by weight of triglycerides compared to the total weight of the fat phase;
from 70.0% to 99.5% by weight of SatOSat+SatSatO triglycerides compared to the total weight of triglycerides;
from 30.0% to 60.0% by weight of POP+PPO triglycerides compared to the total weight of triglycerides;
from 10.0% to 69.5% by weight of StOSt+StStO triglycerides compared to the total weight of triglycerides;
from 1.0% to 3.0% by weight of StOA+StAO+AStO triglycerides compared to the total weight of triglycerides;
from 1.5% to 5.5% by weight of StLiSt+StStLi triglycerides compared to the total weight of triglycerides; and
a ratio of the weight of PPO triglycerides to the weight of POP triglycerides from 0.00 to 0.05; and
a ratio of the weight of SatSatO triglycerides to the weight of SatOSat triglycerides from 0.00 to 0.10
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

The fat composition as disclosed herein shows the possibility to produce chocolate-like compounds without the use of a palm-based vegetable fat phase without compromising the quality. As can be seen by the examples provided herein, it is possible to make a chocolate comprising CBE based on a non-palm oil source as the predominant vegetable fat components in the fat phase, where the resulting chocolate or chocolate-like products is as bloom stable as a product made with a traditional palm-based CBE.

This also means that the present invention as disclosed herein can be used to produce chocolate-like compounds, which are as bloom stable as traditional chocolate or chocolate-like compounds.

Further, the present invention is low or absent of asymmetric (SatSatO) TAGs in the CBE as compared to a CBE comprising Palm mid fraction. This has an added advantage, since the presence of asymmetric TAG's generally result in lower temperature settings in the crystallization and outlet zone of a temper unit, which can have a negative impact to crystallization in the cooling tunnel. Furthermore, a minor impact to texture towards a softer product can also be a consequence of the presence of asymmetric mono-saturated TAGs in the fat composition.

The present invention also relates to use of the fat composition according to the present invention for bakery, dairy, or confectionary applications, or in coating or enrobing for nuts, bakery or confectionary applications, such as bakery or confectionary application, selected from biscuit, cake, muffin, donut, pastry, or bread applications; or for chocolate and chocolate-like coatings.

Further disclosed is also a confectionary or chocolate or chocolate-like product comprising from 10% to 60% by weight, such as from 20% to 55%, such as from 25% and 50%, such as from 28% to 48% by weight of a fat composition according to the present invention.

Even further disclosed is also a fat composition comprising a vegetable fat phase, wherein the vegetable fat phase comprises:
from 85.0% to 100.0% by weight of triglycerides compared to the total weight of the vegetable fat phase;
from 70.0% to 99.5% by weight of SatOSat+SatSatO triglycerides compared to the total weight of triglycerides in the vegetable fat phase;
from 30.0% to 60.0% by weight of POP+PPO triglycerides compared to the total weight of triglycerides in the vegetable fat phase;
from 10.0% to 69.5% by weight of StOSt+StStO triglycerides compared to the total weight of triglycerides in the vegetable fat phase;
from 1.0% to 3.0% by weight of StOA+StAO+AStO triglycerides compared to the total weight of triglycerides in the vegetable fat phase;
from 1.5% to 5.5% by weight of StLiSt+StStLi triglycerides compared to the total weight of triglycerides in the vegetable fat phase; and
a ratio of the weight of PPO triglycerides to the weight of POP triglycerides from 0.00 to 0.05 in the vegetable fat phase; and
a ratio of the weight of SatSatO triglycerides to the weight of SatOSat triglycerides from 0.00 to 0.10 in the vegetable fat phase,
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

### Definitions

In the context of the present invention, the following terms are meant to comprise the following, unless defined elsewhere in the description.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant origin or single cell organism origin.

As used herein, the term “triglycerides” may be used interchangeably with the term “triacylglycerides” and should be understood as an ester derived from glycerol and three fatty acids. “Triglycerides” may be abbreviated TG or TAG.

Saturated fatty acids (SAFA) are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations:

trans or cis. In trans configuration (a trans fatty acid) the carbon chain extends from opposite sides of the double bond, whereas, in cis configuration (a cis fatty acid) the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

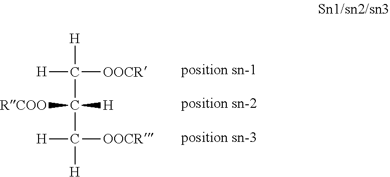

Fischer projection of a natural L-glycerol derivative.

By randomly distributed is meant that the fatty acids are randomly distributed to the three sn-positions. A randomly distributed composition may be obtained by means of esterification, chemical transesterification or enzymatic transesterification. All naturally occurring fat compositions, e.g. virgin olive oil, palm kernel oil, coconut oil or rapeseed oil all have a non-randomly distribution of the fatty acids on the glycerol backbone.

By vegetable fat phase is meant a vegetable fat originating from a plant or a single cell organism. The vegetable fat phase can e.g. be selected from the group of Phulwara, such as Phulwara (Diploknema butyracea), Pequi oil, such as Pequi oil (Caryocar brasiliense), high palmitic sunflower oil, Shea, Kokum, Illipe, Sal and/or Mango oil, or a blend thereof, and/or fractions thereof. It can also be selected from an interesterified, fractionated, and/or hydrogenated version of Phulwara, Pequi oil, high palmitic sunflower oil, Shea, Kokum, Illipe, Sal and/or Mango oil, or a blend thereof, and/or fractions thereof.

As used herein, “%” or “percentage” relates to weight percentage i.e. wt. % or wt.-% if nothing else is indicated.

The sum of a given component in the vegetable fat composition can never be more than 100% by weight, e.g. the sum of all the fatty acid in the vegetable fat composition can never be more than 100% by weight.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter equivalent” or CBE is intended to mean an edible fat having very similar chemical and physical properties and being compatible with cocoa butter. In both cocoa butter and cocoa butter equivalent, the main fatty acids are typically palmitic, stearic, and oleic acids. The triglycerides are typically 2-oleo di-saturated (SatOSat (Sat2O)). Despite their similarity to cocoa butter, cocoa butter equivalents can be detected in chocolate by their triglyceride ratios, which are appreciably different from those in cocoa butter.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

By compound is meant a product made from a combination of cocoa butter and (vegetable) fats. A compound may also comprise milk fat in various amounts. It is used as a lower-cost alternative to true chocolate, as it uses less-expensive hard (vegetable) fats in place of the more expensive cocoa butter. It may also be known as “compound coating” or “chocolatey coating” when used as a coating for confectionary or candy.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

### DETAILED DESCRIPTION OF THE INVENTION

When describing the below embodiments, the present invention envisages all possible combinations and permutations of the below described embodiments with the above disclosed aspects.

The invention relates to a fat composition comprising a vegetable fat phase, wherein the vegetable fat phase comprises:
from 85.0% to 100.0% by weight of triglycerides compared to the total weight of the fat phase;
from 70.0% to 99.5% by weight of SatOSat+SatSatO triglycerides compared to the total weight of triglycerides;
from 30.0% to 60.0% by weight of POP+PPO triglycerides compared to the total weight of triglycerides;
from 10.0% to 69.5% by weight of StOSt+StStO triglycerides compared to the total weight of triglycerides;
from 1.0% to 3.0% by weight of StOA+StAO+AStO triglycerides compared to the total weight of triglycerides;
from 1.5% to 5.5% by weight of StLiSt+StStLi triglycerides compared to the total weight of triglycerides; and
a ratio of the weight of PPO triglycerides to the weight of POP triglycerides from 0.00 to 0.05; and
a ratio of the weight of SatSatO triglycerides to the weight of SatOSat triglycerides from 0.00 to 0.10
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

The fat composition as disclosed herein shows the possibility to produce chocolate-like compounds without the use of a palm-based vegetable fat phase without compromising the quality.

The fat composition as disclosed herein can be used to produce chocolate-like compounds which are as bloom stable as chocolate-like compounds and traditional CBE's comprised of Shea Stearin and palm mid fraction IV 33.

In one or more embodiments, the vegetable fat phase comprises from 90.0% to 100.0% by weight of triglycerides compared to the total weight of the vegetable fat phase, such as from 93.0% to 100.0% by weight.

In one or more embodiments, the vegetable fat phase comprises from 70.0% to 95.0% by weight of SatOSat+SatSatO triglycerides compared to the total weight of triglycerides, such as from 72.0% to 92.0% by weight, such as from 73.0% to 90.0% by weight; wherein Sat is saturated fatty acids selected from C16-, C18-, C20-, C22-, and/or C24-fatty acids, and wherein O is oleic acid (C18:1).

In one or more embodiments, the vegetable fat phase comprises from 32.0% to 58.0% by weight of POP+PPO triglycerides compared to the total weight of triglycerides, such as from 35.0% to 55.0% by weight of POP triglycerides compared to the total weight of triglycerides; P is palmitic acid (C16:0) and O is oleic acid (C18:1).

In one or more embodiments, vegetable fat phase comprises from 15.0% to 65.0% by weight of StOSt+StStO triglycerides compared to the total weight of triglycerides, such as from 20.0% to 55.0% by weight of StOSt triglycerides compared to the total weight of triglycerides; wherein St is steric acid (C18:0) and O is oleic acid (C18:1).

In one or more embodiments, the vegetable fat phase comprises from 1.2% to 2.8% by weight of StOA+StAO+AStO triglycerides compared to the total weight of triglycerides, such as from 1.4% to 2.5% by weight of StOA+StAO+AStO triglycerides compared to the total weight of triglycerides; wherein St is steric acid (C18:0), O is oleic acid (C18:1), and A is arachidic acid (C20:0).

In one or more embodiments, the vegetable fat phase comprises from 1.8% to 5.0% by weight of StLiSt+StStLi triglycerides compared to the total weight of triglycerides, such as from 2.0% to 4.5% by weight of StLiSt triglycerides compared to the total weight of triglycerides; wherein St is steric acid (C18:0) and Li is linoleic acid (C18:2).

In one or more embodiments, the ratio of the weight of PPO triglycerides to the weight of POP triglycerides is from 0.00 to 0.04, such as 0.00 and 0.03; wherein P is palmitic acid (C16:0) and O is oleic acid (C18:1).

In one or more embodiments, the ratio of the weight of StStO triglycerides to the weight of StOSt triglycerides is from 0.00 to 0.08, such as 0.00 and 0.05; wherein Sat is saturated fatty acids selected from C16-, C18-, C20-, C22-, and/or C24-fatty acids, and wherein O is oleic acid (C18:1).

In one or more embodiments, the vegetable fat phase is composed of at least a first triglyceride composition and a second triglyceride composition; wherein the first triglyceride composition is originating from Phulwara oil, Pequi oil, and/or high palmitic sunflower oil, and fractions thereof;

and wherein the second triglyceride composition is originating from Shea, Kokum, Sal, Illipe and/or Mango, and/or fractions thereof.

In one or more embodiments, the vegetable fat phase is composed of at least a first triglyceride composition and a second triglyceride composition; wherein the first triglyceride composition is originating from Phulwara oil and/or Pequi oil, and fractions thereof; and wherein the second triglyceride composition is originating from Shea, Kokum, Sal, Illipe and/or Mango, and/or fractions thereof.

In one or more embodiments, the Phulwara oil is Phulwara oil (Diploknema butyracea) and/or the Pequi oil is Pequi oil (Caryocar brasiliense). Thus in one or more embodiments, the vegetable fat phase is composed of at least a first triglyceride composition and a second triglyceride composition; wherein the first triglyceride composition is originating from Phulwara oil (Diploknema butyracea), Pequi oil (Caryocar brasiliense), and/or high palmitic sunflower oil, and fractions thereof; and wherein the second triglyceride composition is originating from Shea, Kokum, Sal, Illipe, and/or Mango, and/or fractions thereof.

In one or more embodiments, the first triglyceride composition is originating from Phulwara oil (Diploknema butyracea), such as a Phulwara mid fraction, and wherein the second triglyceride composition is originating from shea oil, such as shea stearin.

The examples clearly demonstrate that Phulwara can be used as an alternative to palm fractions to make non-palm CBE compositions.

In one or more embodiments, the first triglyceride composition is in an amount from 40% to 85% by weight of the sum of the first triglyceride composition and the second triglyceride composition, such as 45% to 70% by weight, such as 48% to 67% by weight, or such as 50% to 65% by weight of the sum of the first triglyceride composition and the second triglyceride composition.

In one or more embodiments, the second triglyceride composition is in an amount from 15% to 60% by weight of the sum of the first triglyceride composition and the second triglyceride composition, such as 25% to 55% by weight, such as 30% to 52% by weight, or such as 35% to 50% by weight of the sum of the first triglyceride composition and the second triglyceride composition.

In one or more embodiments, the fat composition is a cocoa butter equivalent (CBE) composition.

Cocoa butter equivalents are e.g. normally made from a mix of palm mid fraction and a fractionated part of shea stearin or another oil fraction rich in SatOSat triglycerides, where Sat is a saturated fatty acid having a chain length of C16 or longer, such as C16 and C18. However, by the present invention, it has shown to be possible to make non-palm cocoa butter equivalents.

Use of the fat composition according to the present invention for bakery, dairy, or confectionary applications, or in coating or enrobing for nuts, bakery or confectionary applications, such as bakery or confectionary application, selected from biscuit, cake, muffin, donut, pastry, or bread applications; or for chocolate and chocolate-like coatings is also disclosed.

Further disclosed is also a confectionary or chocolate or chocolate-like product comprising from 10% to 60% by weight, such as from 20% to 55%, such as from 25% and 50%, such as from 28% to 48% by weight of a fat composition according to the present invention.

The present invention is further illustrated by the following examples, which are not to be construed as limiting the scope of protection.

### EXAMPLES

### Example 1—CBE Compositions

Table 1 displays a typical selected triglyceride composition for a shea stearin IV 36, a palm mid-fraction IV 33, Phulwara (Diploknema butyracea), a Phulwara mid fraction, High Oleic sunflower oil and West Africa cocoa butter measured by AOCS method Ce 5b-89. The asymmetric isomers are included in the amount specified under each TAGs in the examples since the method used (AOCS Ce 5b-89) does not measure the difference in isomeric state of a TAG. Hence, for example, when there is written POSt in the tables it also includes its isomers; PStO and StPO.

The content of PPO was determined using a well-known method by a commercial laboratory. The amount of the asymmetric PPO isomer is measured using an absolute method. Thereafter, the ratio of PPO/POP triglycerides was calculated.

The Phulwara mid fraction was obtained via acetone solvent fractionation with a ratio of oil to solvent at 1 to 6. First fractionation at 20° C. resulted in 12% Stearin and 88% olein. Secondly the Elain was fractionated once more at 0° C. to obtain 71% Stearin (mid fraction) and 29% olein (double olein/super olein).

TABLE 1

| | | | Phulwara | | West |
|---|---|---|---|---|---|
| Shea | Palm mid | Phulwara | (Diploknema | High Oleic | African |
| Stearin | fraction IV | (Diploknema | butyracea) | sunflower | cocoa |
| IV 36 | 33 | butyracea) | mid fraction | oil | butter |

Triglyceride composition*

| | | | | | | |
|---|---|---|---|---|---|---|
| MOP/wt. % | — | 2.2 | 0.8 | 0.8 | — | 0.2 |
| POP/wt. % | 1.0 | 66.7 | 63.1 | 80.0 | 0.3 | 15.2 |
| POSt/wt. % | 7.9 | 13.5 | 5.2 | 6.5 | 0.5 | 37.8 |
| StOSt/wt. % | 67.4 | 1.6 | 0.3 | 0.4 | 0.2 | 27.1 |
| StOA/wt. % | 3.7 | 0.2 | — | — | — | 1.5 |
| AOA/wt. % | 0.3 | 0.1 | — | — | — | 0.3 |
| StLiSt/wt. % | 6.6 | 0.1 | 0.1 | 0.0 | 0.0 | 2.0 |
| Total SatOSat/ | 80.3 | 84.3 | 69.4 | 87.7 | 1.0 | 82.1 |
| wt. % | | | | | | |
| Total SatSatSat/ | 1.7 | 3.5 | 5.8 | 2.4 | 0.9 | 1.4 |
| wt. % | | | | | | |

Triglyceride position ratio

| | | | | | | |
|---|---|---|---|---|---|---|
| PPO/POP | 0.00 | 0.07 | 0.00 | 0.00 | n.d. | 0.00 |

*Measured using AOCS Ce5b-89

Table 2 shows the selected triglyceride composition of West African cocoa butter compared to four CBEs made of at least two components among Shea stearin IV 36, Palm mid fraction IV 33, Phulwara and Phulwara mid fraction and high oleic sunflower oil.

TABLE 2

| | CBE | | CBE | CBE II |
|---|---|---|---|---|
| Cocoa | comparative I | CBE I | comparative II | 10829 |
| Butter | 10829 | 10831 | DK-C11 | No exp data |

Component

| | | | | | |
|---|---|---|---|---|---|
| West African | 100.0 | — | — | — | — |
| cocoa butter/wt. % | | | | | |
| Shea Stearin IV | — | 46.0 | 46.0 | 46.0 | 46.0 |
| 36/wt. % | | | | | |
| PMF IV 33/wt. % | — | 44.0 | — | 54.0 | — |
| Phulwara/wt. % | — | — | 54.0 | — | |
| Phulwara mid | — | — | — | — | 54.0 |
| fraction/wt. % | | | | | |
| High Oleic | — | 10.0 | — | — | — |
| sunflower oil/wt. % | | | | | |

Triglyceride composition*

| | | | | | |
|---|---|---|---|---|---|
| MOP/wt. % | 0.2 | 1.0 | 0.4 | 1.2 | 0.4 |
| POP/wt. % | 15.2 | 29.8 | 34.5 | 36.5 | 43.7 |
| POSt/wt. % | 37.8 | 9.6 | 6.4 | 10.9 | 7.1 |
| StOSt/wt. % | 27.1 | 31.7 | 31.2 | 31.9 | 31.2 |
| StOA/wt. % | 1.5 | 1.8 | 1.7 | 1.8 | 1.7 |
| AOA/wt. % | 0.3 | 0.2 | 0.1 | 0.2 | 0.1 |
| StLiSt/wt. % | 2.0 | 3.1 | 3.1 | 3.1 | 3.0 |
| Total SatOSat/wt. % | 82.1 | 74.1 | 74.4 | 82.5 | 84.3 |
| Total SatSatSat/wt. % | 1.4 | 2.4 | 3.9 | 2.7 | 2.1 |

Triglyceride position isomer

| | | | | | |
|---|---|---|---|---|---|
| PPO/POP | 0.00 | 0.07 | 0.00 | 0.07 | 0.00 |

*Measured using AOCS Ce5b-89 - Relative measurements summing the TAG composition to 100%.

A comparison of the mono-unsaturated TAG compositions for CBE I and CBE comparative I as well as CBE II and CBE comparative II show comparable StOSt and SatOSat contents. However, the Phulwara based CBE I and CBE II have higher POP content at the expense of POSt as compared to CBE comparative I and II.

Furthermore, the PPO/POP ratio for CBE I and II are substantially lower than the comparative CBE I and II comprising Palm mid fraction IV 33.

### Example 2: Recipes and Manufacture of Chocolate-Like Compounds with CBE Compositions

The procedure of the chocolate productions were all done following this procedure:

All ingredients, except lecithin and some of the fat, are mixed on a teddy mixer with heat jacket to a consistency of marzipan. Afterwards, the mixture is refined on a three-roller Bühler refiner to an average particle size of 20 micron. The mass is then dry-conched for 3 hours at 65° C. for three hours before the remaining fat is added and then followed by wet-couching for 3 hours. Half an hour before conching is complete lecithin is added. The chocolates are then transferred to an Aasted AMC 50 three zone tempering machine to be optimally tempered. Tempering settings are adjusted until a well temper curve with the highest possible inflection point is obtained on an exotherm 7400 Temper Meter. The inflection point correlates to the crystallization point of the product.

The chocolates are then deposited into 50 g preheated molds and placed in a three-zone cooling tunnel for 30 minutes. Temperatures are adjusted to 15° C. in zone 1 and 3 and 12° C. in zone 2. The demolded chocolate tablets are kept at 20° C. for one week and then moved to 20° C. and 25° C. cabinet for isothermal storage. Once a week the tablets are evaluated by a trained panel of experts for visible bloom. The number of weeks until the appearance of strong bloom on the surface of the chocolate tablets are noted as the shelf life result (see table 4 below).

Chocolate recipe and fat composition as well as plateau and slope for temper curves are given in Table 3.

The tempering of the Phulwara based CBE I and II on the Aasted AMC 50 three zone tempering machine was straight forward with comparable temperature settings as the CBE comparable I and II, respectively. Furthermore, no viscosity build-up over time in the recirculated chocolates were observed. This combined with comparable inflection points as the comparable CBE's strongly indicate that Phulwara based CBE will be workable in chocolate applications with respect to the production process.

The absence of asymmetric PPO in the CBE of the invention as compared to the comparative CBE comprising Palm mid fraction IV 33 is an added advantage of the present invention, as the presence of PPO or asymmetric TAG's in general generally result in lower temperature settings in the crystallization and outlet zone of the temper unit, which can have a negative impact to crystallization in the pursuing cooling tunnel. Furthermore, a minor impact to texture towards a softer product can also be a consequence of the presence of asymmetric monounsaturated (SatSatO) TAGs in the fat composition.

TABLE 3

| Chocolate reference and chocolates with CBE's | | | | |
|---|---|---|---|---|
| Cocoa | CBE | | CBE | |
| Butter | comparative I | CBE I | comparative II | CBE II |

Recipe

| | | | | | |
|---|---|---|---|---|---|
| Sugar/wt. % | 49.58 | 49.58 | 49.58 | 49.58 | 49.58 |
| Cocoa powder (11% CB)/wt. % | 15.00 | 15.00 | 15.00 | 15.00 | 15.00 |
| Skim milk powder/wt. % | 5.00 | 5.00 | 5.00 | 5.00 | 5.00 |
| Lecithin/wt. % | 0.4 | 0.4 | 0.4 | 0.4 | 0.4 |
| Vanillin/wt. % | 0.02 | 0.02 | 0.02 | 0.02 | 0.02 |
| Cocoa butter/wt. % | 30.00 | — | — | — | — |
| CBE comparative I/wt. % | — | 30.00 | — | — | — |
| CBE I/wt. % | — | — | 30.00 | — | — |
| CBE comparative II/wt. % | — | — | — | 30.00 | — |
| CBE II/wt. % | — | — | — | — | 30.00 |
| Total fat content/wt. % | 31.7 | 31.7 | 31.7 | 31.7 | 31.7 |

Fat composition

| | | | | | |
|---|---|---|---|---|---|
| Cocoa butter/wt. % | 99.8 | 5.2 | 5.2 | 5.2 | 5.2 |
| CBE comparative I/wt. % | — | 94.6 | — | — | — |
| CBE I/wt. % | — | — | 94.6 | — | — |
| CBE comparative II/wt. % | — | — | — | 94.6 | — |
| CBE II/wt. % | — | — | — | — | 94.6 |
| Milk fat/wt. % | 0.2 | 0.2 | 0.2 | 0.2 | 0.2 |

Temper curves

| | | | | | |
|---|---|---|---|---|---|
| Inflection point/° C. | 23.8 | 23.1 | 23.4 | 23.2 | 23.8 |
| Slope | −0.08 | −0.24 | −0.36 | 0.16 | −0.20 |

### Example 3—Shelf-Life Evaluation

The shelf-life results are given in Table 4. The shelf-life results demonstrate that it is possible to make a chocolate comprising CBE based on Shea Stearin and Phulwara or Shea Stearin and Phulwara mid fraction as the predominant vegetable fat components in the fat phase which are as bloom stable as chocolate and traditional CBE's comprised of Shea Stearin and palm mid fraction IV 33.

TABLE 4

| Chocolate reference and chocolates with CBE's | | | | |
|---|---|---|---|---|
| Cocoa | CBE | | CBE | CBE II |
| Butter | comparative I | CBE I | comparative II | 10829 |
| 9439 | 10829 | 10831 | DK-C11 | No exp data |

Bloom Stability

| | | | | | |
|---|---|---|---|---|---|
| Weeks before strong | >52 | >52 | >52 | >52 | >52 |
| bloom at 20° C. | | | | | |
| isothermal storage | | | | | |
| Weeks before strong | 8 | 7 | 8 | 14 | 16 |
| bloom at 25° C. | | | | | |
| isothermal storage | | | | | |

To conclude; the examples clearly demonstrate that a non-palm oil source, such as Phulwara, can be used as an alternative to palm fractions to make non-palm CBE compositions.

1. A fat composition comprising a vegetable fat phase, wherein the vegetable fat phase comprises:
from 85.0% to 100.0% by weight of triglycerides compared to the total weight of the vegetable fat phase;
from 70.0% to 99.5% by weight of SatOSat+SatSatO triglycerides compared to the total weight of triglycerides in the vegetable fat phase;
from 30.0% to 60.0% by weight of POP+PPO triglycerides compared to the total weight of triglycerides in the vegetable fat phase;
from 10.0% to 69.5% by weight of StOSt+StStO triglycerides compared to the total weight of triglycerides in the vegetable fat phase;
from 1.0% to 3.0% by weight of StOA+StAO+AStO triglycerides compared to the total weight of triglycerides in the vegetable fat phase;
from 1.5% to 5.5% by weight of StLiSt+StStLi triglycerides compared to the total weight of triglycerides in the vegetable fat phase; and
a ratio of the weight of PPO triglycerides to the weight of POP triglycerides from 0.00 to 0.05 in the vegetable fat phase; and
a ratio of the weight of SatSatO triglycerides to the weight of SatOSat triglycerides from 0.00 to 0.10 in the vegetable fat phase,
wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

2. The fat composition according to claim 1, wherein the vegetable fat phase comprises from 90.0% to 100.0% by weight of triglycerides compared to the total weight of the vegetable fat phase.

3. The fat composition according to claim 1, wherein the vegetable fat phase comprises from 70.0% to 95.0% by weight of SatOSat+SatSatO triglycerides compared to the total weight of triglycerides; wherein Sat is saturated fatty acids selected from C16-, C18-, C20-, C22-, and/or C24-fatty acids, and wherein O is oleic acid (C18:1).

4. The fat composition according to claim 1, wherein the vegetable fat phase comprises from 32.0% to 58.0% by weight of POP+PPO triglycerides compared to the total weight of triglycerides; wherein P is palmitic acid (C16:0) and O is oleic acid (C18:1).

5. The fat composition according to claim 1, wherein the vegetable fat phase comprises from 15.0% to 65.0% by weight of StOSt+StStO triglycerides compared to the total weight of triglycerides; wherein St is steric acid (C 18:0) and O is oleic acid (C18:1).

6. The fat composition according to claim 1, wherein the vegetable fat phase comprises from 1.2% to 2.8% by weight of StOA+StAO+AStO triglycerides compared to the total weight of triglycerides; wherein St is steric acid (C18:0), O is oleic acid (C18:1), and A is arachidic acid (C20:0).

7. The fat composition according to claim 1, wherein the vegetable fat phase comprises from 1.8% to 5.0% by weight of StLiSt+StStLi triglycerides compared to the total weight of triglycerides; wherein St is steric acid (C18:0) and Li is linoleic acid (C18:2).

8. The fat composition according to claim 1, wherein the ratio of the weight of PPO triglycerides to the weight of POP triglycerides is from 0.00 to 0.04; wherein P is palmitic acid (C16:0) and O is oleic acid (C18:1).

9. The fat composition according to claim 1, wherein the ratio of the weight of StStO triglycerides to the weight of StOSt triglycerides is from 0.00 to 0.08; wherein Sat is saturated fatty acids selected from C16-, C18-, C20-, C22-, and/or C24-fatty acids, and wherein O is oleic acid (C18:1).

10. The fat composition according to claim 1, preceding claims, wherein the vegetable fat phase is composed of at least a first triglyceride composition and a second triglyceride composition; wherein the first triglyceride composition is originating from Phulwara, Pequi oil, and/or high palmitic sunflower oil, and fractions thereof; and wherein the second triglyceride composition is originating from Shea, Kokum, Sal, Illipe, and/or Mango, and/or fractions thereof.

11. The fat composition according to claim 10, wherein the first triglyceride composition is originating from Phulwara oil, and wherein the second triglyceride composition is originating from shea oil.

12. The fat composition according to claim 10, wherein the first triglyceride composition is in an amount from 40% to 85% by weight of the sum of the first triglyceride composition and the second triglyceride composition.

13. The fat composition according to claim 10, wherein the second triglyceride composition is in an amount from 15% to 60% by weight of the sum of the first triglyceride composition and the second triglyceride composition.

14. The fat composition according to claim 1, wherein the fat composition is a cocoa butter equivalent (CBE) composition.

15. A method of making a fat composition, comprising addition of the vegetable fat phase according to claim 1, the fat composition employed for bakery, dairy, or confectionary applications, or in coating or enrobing for nuts, bakery or confectionary applications; or for chocolate and chocolate-like coatings.

16. A confectionary or chocolate or chocolate-like product comprising from 10% to 60% by weight of a fat composition according to claim 1.
